(19) United States
(12) Patent Application Publication
(10) Pub. No.: US 2023/0269022 A1
(43) Pub. Date: Aug. 24, 2023

(54) LINK ADAPTATION IMPROVEMENT WITH PCI REPORTING ENHANCEMENTS

(71) Applicant: NOKIA TECHNOLOGIES OY, Espoo (FI)

(72) Inventors: Lauri Ilari KURU, Espoo (FI); Antti Anton TOSKALA, Espoo (FI)

(21) Appl. No.: 18/014,421

(22) PCT Filed: Jul. 13, 2021
(86) PCT No.: PCT/EP2021/069392

§ 371 Date: Jan. 4, 2023

Related U.S. Application Data
(60) Provisional application No. 62/705,757, filed on Jul. 14, 2020.

(51) Int. Cl. H04L 1/00

(52) U.S. Cl. CPC H04L 1/0003; H04L 1/0026; H04L 1/0017

(57) ABSTRACT

A method, apparatus, and a computer-readable storage medium are provided for radio link adaptation. In an example implementation, the method may include a user equipment receiving measurement configuration from a network node; determining power level and/or distribution characteristics of a signal received from the network node; determining mean interference at the user equipment and a number of physical cell identifiers detected by the user equipment; transmitting the distribution characteristics of the signal, the mean interference, and the number of physical cell identifiers that are detected by the user equipment to the network node; and receiving a transmission from the network node, the transmission transmitted by the network node using a modulation and coding scheme determined based at least on the distribution characteristics, the mean inference, and the number of physical cell identifiers.

### TECHNICAL FIELD

This description relates to wireless communications, and in particular, radio link adaptation.

### BACKGROUND

A communication system may be a facility that enables communication between two or more nodes or devices, such as fixed or mobile communication devices. Signals can be carried on wired or wireless carriers.

An example of a cellular communication system is an architecture that is being standardized by the 3rd Generation Partnership Project (3GPP). A recent development in this field is often referred to as the long-term evolution (LTE) of the Universal Mobile Telecommunications System (UMTS) radio-access technology. E-UTRA (evolved UMTS Terrestrial Radio Access) is the air interface of 3GPP's Long Term Evolution (LTE) upgrade path for mobile networks. In LTE, base stations or access points (APs), which are referred to as enhanced Node AP or Evolved Node B (eNBs), provide wireless access within a coverage area or cell. In LTE, mobile devices, or mobile stations are referred to as user equipments (UE). LTE has included a number of improvements or developments.

5G New Radio (NR) development is part of a continued mobile broadband evolution process to meet the requirements of 5G, similar to earlier evolution of 3G & 4G wireless networks. In addition, 5G is also targeted at the new emerging use cases in addition to mobile broadband. A goal of 5G is to provide significant improvement in wireless performance, which may include new levels of data rate, latency, reliability, and security. 5G NR may also scale to efficiently connect the massive Internet of Things (IoT), and may offer new types of mission-critical services. Ultra reliable and low latency communications (URLLC) devices may require high reliability and very low latency.

### SUMMARY

Various example implementations are described and/or illustrated. The details of one or more examples of implementations are set forth in the accompanying drawings and the description below. Other features will be apparent from the description and drawings, and from the claims.

A method, apparatus, and a computer-readable storage medium are provided for radio link adaptation. In an example implementation, the method may include a user equipment receiving measurement configuration from a network node; determining power level and/or distribution characteristics of a signal received from the network node; determining mean interference at the user equipment and a number of physical cell identifiers detected by the user equipment; transmitting the distribution characteristics of the signal, the mean interference, and the number of physical cell identifiers that are detected by the user equipment to the network node; and receiving a transmission from the network node, the transmission transmitted by the network node using a modulation and coding scheme determined based at least on the distribution characteristics, the mean interference, and the number of physical cell identifiers.

In another example implementation, the method may include a network node transmitting measurement configuration to a user equipment; receiving distribution characteristics of a signal received by the user equipment and mean interference at the user equipment; receiving a number of physical cell identifiers detected by the user equipment; determining distribution characteristics of signal to interference plus noise ratio at the user equipment, the determining of the distribution characteristics of the signal to interference plus noise ratio based at least on the distribution characteristics of the signal received, mean interference at the user equipment, and/or the number of physical cell identifiers; determining modulation and coding scheme of a transmission based at least on the distribution characteristics of the signal to interference plus noise ratio; and transmitting the transmission to the user equipment using a modulation and coding scheme determined based at least on the distribution characteristics of the signal to interference plus noise ratio.

### BRIEF DESCRIPTION OF THE DRAWINGS

FIG. 1 is a block diagram of a wireless network according to an example implementation.

FIGS. 2-4 illustrate link adaptation mechanisms, according to various example implementations.

FIGS. 5-6 illustrate flow charts illustrating link adaptation mechanisms, according to various example implementations.

FIG. 7 is a chart illustrating cumulative distribution functions (CDFs) of observed signal to interference plus noise ratio (SINR) standard deviation (std) distributions, according to an example implementation.

FIG. 8 is a block diagram of a node or wireless station (e.g., base station/access point or mobile station/user device/UE), according to an example implementation.

### DETAILED DESCRIPTION

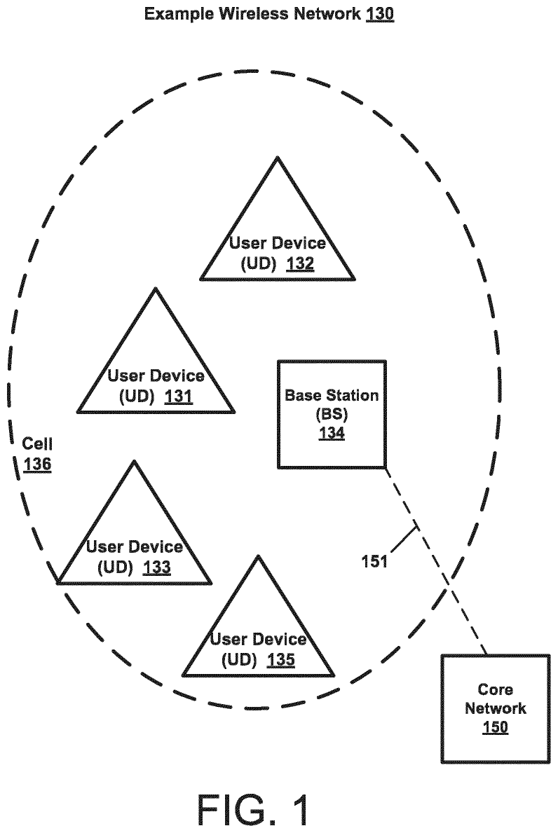

FIG. 1 is a block diagram of a wireless network 130 according to an example implementation. In the wireless network 130 of FIG. 1, user devices (UDs) 131, 132, 133 and 135, which may also be referred to as mobile stations (MSs) or user equipment (UEs), may be connected (and in communication) with a base station (BS) 134, which may also be referred to as an access point (AP), an enhanced Node B (eNB), a next-generation Node B (gNB) or a network node. At least part of the functionalities of an access point (AP), base station (BS), (e)Node B (eNB), or gNB may also be carried out by any node, server or host which may be operably coupled to a transceiver, such as a remote radio head. BS (or AP) 134 provides wireless coverage within a cell 136, including to user devices 131, 132, 133 and 135. Although only four user devices are shown as being connected or attached to BS 134, any number of user devices may be provided. BS 134 is also connected to a core network 150 via a S1 interface 151. This is merely one simple example of a wireless network, and others may be used.

A user device (user terminal, user equipment (UE)) may refer to a portable computing device that includes wireless mobile communication devices operating with or without a subscriber identification module (SIM), including, but not limited to, the following types of devices: a mobile station (MS), a mobile phone, a cell phone, a smartphone, a personal digital assistant (PDA), a handset, a device using a wireless modem (alarm or measurement device, etc.), a laptop and/or touch screen computer, a tablet, a phablet, a game console, a notebook, and a multimedia device, as examples, or any other wireless device. It should be appreciated that a user device may also be a nearly exclusive uplink only device, of which an example is a camera or video camera loading images or video clips to a network.

In LTE (as an example), core network 150 may be referred to as Evolved Packet Core (EPC), which may include a mobility management entity (MME) which may handle or assist with mobility/handover of user devices between BSs, one or more gateways that may forward data and control signals between the BSs and packet data networks or the Internet, and other control functions or blocks.

In addition, by way of illustrative example, the various example implementations or techniques described herein may be applied to various types of user devices or data service types, or may apply to user devices that may have multiple applications running thereon that may be of different data service types. New Radio (5G) development may support a number of different applications or a number of different data service types, such as for example: machine type communications (MTC), enhanced machine type communication (eMTC), Internet of Things (IoT), and/or narrowband IoT user devices, enhanced mobile broadband (eMBB), and ultra-reliable and low-latency communications (URLLC).

IoT may refer to an ever-growing group of objects that may have Internet or network connectivity, so that these objects may send information to and receive information from other network devices. For example, many sensor type applications or devices may monitor a physical condition or a status, and may send a report to a server or other network device, e.g., when an event occurs. Machine Type Communications (MTC or machine to machine communications) may, for example, be characterized by fully automatic data generation, exchange, processing and actuation among intelligent machines, with or without intervention of humans. Enhanced mobile broadband (eMBB) may support much higher data rates than currently available in LTE.

Ultra-reliable and low-latency communications (URLLC) is a new data service type, or new usage scenario, which may be supported for New Radio (5G) systems. This enables emerging new applications and services, such as industrial automations, autonomous driving, vehicular safety, e-health services, and so on. 3GPP targets in providing up to e.g., 1 ms U-Plane (user/data plane) latency connectivity with 1-1e-5 reliability, by way of an illustrative example. Thus, for example, URLLC user devices/UEs may require a significantly lower block error rate than other types of user devices/UEs as well as low latency. Thus, for example, a URLLC UE (or URLLC application on a UE) may require much shorter latency, as compared to an eMBB UE (or an eMBB application running on a UE).

The various example implementations may be applied to a wide variety of wireless technologies or wireless networks, such as LTE, LTE-A, 5G, IoT, MTC, eMTC, eMBB, URLLC, etc., or any other wireless network or wireless technology. These example networks, technologies or data service types are provided only as illustrative examples.

Multiple Input, Multiple Output (MIMO) may refer to a technique for increasing the capacity of a radio link using multiple transmit and receive antennas to exploit multipath propagation. MIMO may include the use of multiple antennas at the transmitter and/or the receiver. MIMO may include a multi-dimensional approach that transmits and receives two or more unique data streams through one radio channel. For example, MIMO may refer to a technique for sending and receiving more than one data signal simultaneously over the same radio channel by exploiting multipath propagation. According to an illustrative example, multi-user multiple input, multiple output (multi-user MIMIO, or MU-MIMO) enhances MIMO technology by allowing a base station (BS) or other wireless node to simultaneously transmit or receive multiple streams to different user devices or UEs, which may include simultaneously transmitting a first stream to a first UE, and a second stream to a second UE, via a same (or common or shared) set of physical resource blocks (PRBs) (e.g., where each PRB may include a set of time-frequency resources).

Also, a BS may use precoding to transmit data to a UE (based on a precoder matrix or precoder vector for the UE). For example, a UE may receive reference signals or pilot signals, and may determine a quantized version of a DL channel estimate, and then provide the BS with an indication of the quantized DL channel estimate. The BS may determine a precoder matrix based on the quantized channel estimate, where the precoder matrix may be used to focus or direct transmitted signal energy in the best channel direction for the UE. Also, each UE may use a decoder matrix may be determined, e.g., where the UE may receive reference signals from the BS, determine a channel estimate of the DL channel, and then determine a decoder matrix for the DL channel based on the DL channel estimate. For example, a precoder matrix may indicate antenna weights (e.g., an amplitude/gain and phase for each weight) to be applied to an antenna array of a transmitting wireless device. Likewise, a decoder matrix may indicate antenna weights (e.g., an amplitude/gain and phase for each weight) to be applied to an antenna array of a receiving wireless device. This applies to UL as well when a UE is transmitting data to a BS.

For example, according to an example aspect, a receiving wireless user device may determine a precoder matrix using Interference Rejection Combining (IRC) in which the user device may receive reference signals (or other signals) from a number of BSs (e.g., and may measure a signal strength, signal power, or other signal parameter for a signal received from each BS), and may generate a decoder matrix that may suppress or reduce signals from one or more interferers (or interfering cells or BSs), e.g., by providing a null (or very low antenna gain) in the direction of the interfering signal, in order to increase a signal-to interference plus noise ratio (SINR) of a desired signal. In order to reduce the overall interference from a number of different interferers, a receiver may use, for example, a Linear Minimum Mean Square Error Interference Rejection Combining (LMMSE-IRC) receiver to determine a decoding matrix. The IRC receiver and LMMSE-IRC receiver are merely examples, and other types of receivers or techniques may be used to determine a decoder matrix. After the decoder matrix has been determined, the receiving UE/user device may apply antenna weights (e.g., each antenna weight including amplitude and phase) to a plurality of antennas at the receiving UE or device based on the decoder matrix. Similarly, a precoder matrix may include antenna weights that may be applied to antennas of a transmitting wireless device or node. This applies to a receiving BS as well.

A radio link, also referred to as a radio frequency (RF) link, for example, may be a wireless (e.g., cellular) connection between an access node and a terminal device and may be optimized during the wireless connection. However, the RF environment conditions may not be stable (e.g., constantly changing) and thereby affect the conditions of the radio link. Link adaptation mechanisms may be used to adapt the link to the changes in the RF environment.

Without proper understanding of the environment characteristics, URLLC operations may need to be dimensioned (e.g., configured, provisioned, etc.) according to worst case interference scenario. This may result in over-dimensioning of URLLC and the system may select conservative (e.g., less efficient) modulation and coding scheme for transmissions to meet ultra-high reliability requirements of URLLC while significantly reducing network capacity. For proper link adaptation, e.g., accurate determination of a modulation and coding scheme (MCS), the system requires knowledge of the SINR distribution experienced by a receiver (e.g., user equipment, UE). Therefore, there is a desire and/or need to estimate SINR distribution and provide it to a network node (e.g., gNB).

The present disclosure describes mechanisms for link adaptation improvements. In an example implementation, a gNB may receive (e.g., from a UE) distribution characteristics of a signal received by the UE (e.g., a signal from the gNB to the UE) and a count of physical cell IDs (PCIs) detected by the UE. The gNB may determine SINR distribution characteristics based on the information received from the UE and may use the determined SINR distribution characteristics to determine modulation and coding scheme (MCS) for a transmission to the UE. The use of SINR distribution characteristics to determine the MCS for a transmission to the UE provides for efficient communications (e.g., optimal MCS).

In an example implementation, the present disclosure describes a link adaptation mechanism which may include a UE receiving measurement configuration from a network node and determining power level and/or distribution characteristics of a signal received from the network node. The method may further include determining a number of physical cell identifiers detected by the user equipment, transmitting the distribution characteristics of the signal and the number of physical cell identifiers that are detected by the user equipment to the network node, and receiving a transmission from the network node, the transmission transmitted by the network node using a modulation and coding scheme determined based at least on the distribution characteristics and the number of physical cell identifiers.

In another example implementation, the present disclosure describes a link adaptation mechanism which may include a network node (e.g., gNB) transmitting measurement configuration to a user equipment, receiving distribution characteristics of a signal received by the user equipment, and receiving a number of physical cell identifiers detected by the user equipment. The method may further include determining distribution characteristics of signal to interference plus noise ratio at the user equipment, the determining of the distribution characteristics of the signal to interference plus noise ratio based at least on the distribution characteristics of the signal received and/or the number of physical cell identifiers, determining, by the network node, modulation and coding scheme of a transmission based at least on the distribution characteristics of the signal to interference plus noise ratio, and transmitting the transmission to the user equipment using a modulation and coding scheme determined based at least on the distribution characteristics of the signal to interference plus noise ratio.

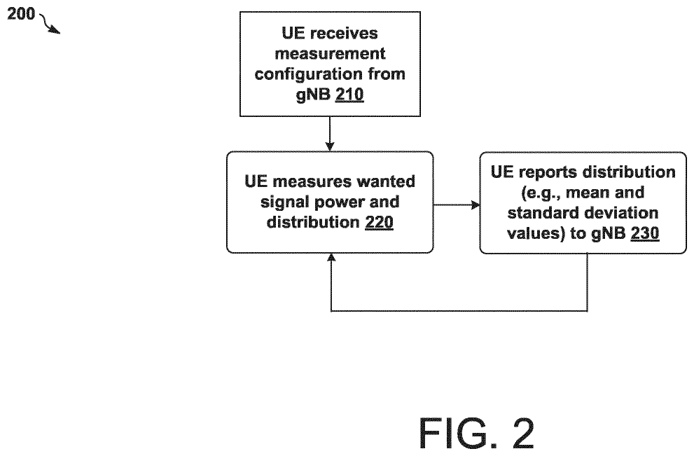

FIG. 2 illustrates a link adaptation mechanism 200, according to an example implementation.

In an example implementation, at 210, a UE, e.g., UE 202, which may be same or similar to user device 131 of FIG. 1, may receive measurement configuration (for example, as defined in 3GPP TS 38.331) from a gNB, e.g., gNB 204, which may be same or similar to BS 134 of FIG. 1. The UE may receive the measurement configuration via radio resource control (RRC) signaling (e.g., signaling radio bearer, SRB) from the gNB. The UE, in response to the receiving of the measurement configuration from the gNB, may perform measurements as per the information indicated (or included) in the measurement configuration and/or may send a measurement report to the gNB. In some implementations, for example, the measurement configuration may include the following parameters, e.g., measurement objects, reporting configurations, measurement identities, quantity configurations, and/or measurement gaps, as defined in 3GPP TS 38.331.

At 220, UE 202 may measure a power of a signal (e.g., signal power) received from the gNB, the signal also referred to as a “wanted signal,” in the present disclosure. In an example implementation, the signal (or the wanted signal) may be a channel state information reference signal (CSI-RS) or a synchronization signal block (SSB). In another example implementation, the signal may be a user plane signal, e.g., a physical downlink shared channel (PDSCH). In addition, in some implementations, the UE may determine distribution characteristics of the signal received from the gNB. In an example implementation, the distribution characteristics may include determining (or computing) at least mean and/or standard deviation values of the signal received from the gNB.

In some implementations, for example, the gNB may need information about SINR characteristics (in other words, interference information at the UE) to determine the proper MCS. This may be achieved in several ways. In an example implementation, the UE may measure SINR from, for example, CSI-RS, SSB, PDSCH, etc., and may report the measured SINR to the gNB. In an additional example implementation, the UE may measure the signal S from CSI-RS and may measure the interference I from CSI interference measurement (CSI-IM) and report them to the gNB. In another additional example implementation, the UE may measure a channel quality indicator (CQI) and report it to the gNB to indicate the MCS recommended by the UE. The existing CQI reporting mechanism is limited by 3GPP Specifications, for example, the CQI report applies to one TBS size which is currently a large value and reports for small TBS sizes may not be possible. Although, the reports from the UE may include mean values of S, I, SINR, and CQI, distribution information is not included.

Therefore, the present disclosure recites reporting distribution information of signal S (in an example implementation, reporting standard deviation of signal S) and reporting distribution information of interference I (in an example implementation, reporting PCI count which correlates with distribution of I and which may be easily measured by the UE). In some implementations, for example, the gNB may determine the SINR distribution even if the distribution of signal S (e.g., mean and std values) and distribution of interference I (e.g., mean and std values) are reported separately. In the present disclosure, the distribution information (or characteristics) may refer to mean values, standard deviation values, or both. In an additional example implementation, the UE may also report CQI to the gNB which may be used for determining SINR distribution.

In an example implementation, the measurement configuration received from the gNB at 210 may include a measurement object (e.g., one or more measurement objects) which may indicate the objects (e.g., signal power, distribution characteristics, etc.) to be measured. In some implementations, for example, the measurement object may be a new measurement object or an existing measurement object which may be configured to support performing of the measurements, as described in the present disclosure. In some implementations, for example, the distribution characteristics of the signal received from the gNB may be determined on a per sample basis, the sample being a resource element (RE) or a physical resource block (PRB).

In some implementations, for example, the distribution samples may be collected in a frequency domain and may be collected over the time transmission intervals (TTIs) which can be measured between consecutive UE reports (e.g., according to the configuration provided by gNB). In an example implementation, the measurement report from the UE may be based on the last measurement before reporting, but better information may be obtained if measurements between two reports are collected.

At 230, UE 202 may report the distribution characteristics of the signal to gNB 204. In an example implementation, the distribution characteristics of the signal may include measurements such as standard deviation, mean, etc., of the signal. In some implementations, the distribution characteristics (e.g., standard deviation of the signal) may be reported to the gNB via a measurement report. The distribution characteristics of the signal measured and transmitted to the gNB may be used by the gNB to determine (or select) modulation and coding scheme (MCS) for a following transmission (e.g., packet, transmission time interval (TTI), etc.) from the gNB to the UE. The MCS, which may include modulation mechanism and/or code rate, may depend on radio link quality and/or may define the number of bits that may be transmitted per resource element (RE) from the gNB to the UE.

For example, if the radio link quality of a link between gNB and UE is good, higher MCS may be used and higher amount of data may be transmitted from the gNB to the UE. Similarly, if the radio link quality is not good, lower MCS (vs higher MCS) may be used, and lesser amount of data may be transmitted from the gNB to the UE. As the MCS selection may depend on error probability at the UE, in some implementations, for example, an error probability threshold may be defined for a transmission to a UE which may be considered when selecting the appropriate MSC. It should be noted that under varying radio conditions, the MCS may be selected such that the error probability is not higher than the error probability threshold. In some implementations, the MCS selection may be performed on a packet basis (e.g., per packet) or on a transmission time interval (TTI) basis (e.g., per TTI) for each active user communicating with the gNB.

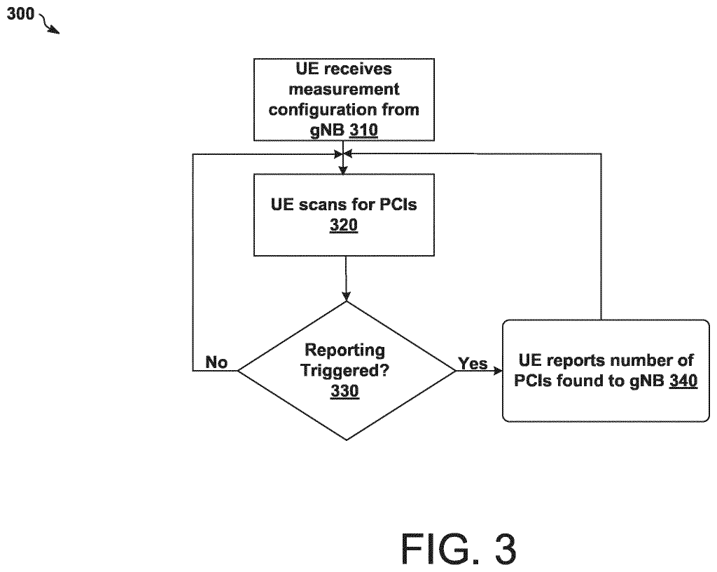

FIG. 3 illustrates a link adaptation mechanism 300, according to an additional example implementation.

In some implementations, for example, at 310, a UE, e.g., UE 202, may receive measurement configuration from a gNB, e.g., gNB 204, in a manner similar to 210 of FIG. 2. The UE may receive the measurement configuration via RRC/SRB from the gNB.

At 320, UE 202 may scan for cells (e.g., other cells), which may be a continuous operation, in the vicinity of the UE by performing a search for physical cell IDs (PCIs) of other cells. A PCI identifies a cell in a network, and in some implementations, for example, a PCI value may be based on a combination of a primary synchronization signal and a secondary synchronization signal. In an example implementation, the UE may scan for PCIs on the carrier signal by observing SSBs transmitted by other gNBs/cells in the vicinity. The number of PCIs detected by the UE may be used for determining the distribution characteristics of noise and interference at the UE.

In some implementations, for example, the UE may scan for PCIs within a power window. In some other implementations, for example, the power window may be defined relative to the power level of a serving cell signal. For example, the UE may scan for PCIs within “X” dB (e.g., 6 dB) of the power of the serving cell. This is just one example implementation and not a limitation and other power windows may be configured as well. In an example implementation, the gNB may notify the UE of the power window via, for example, the measurement configuration. In some implementations, for example, the gNB may configure a plurality of power windows, e.g., a first power window (6 dB) and a second power window (10 dB).

At 330, UE 202 may determine whether the reporting is triggered at the UE. In an example implementation, the reporting by the UE may be performed periodically. In another example implementation, the reporting by the UE may be triggered (e.g., initiated) in response to a condition being satisfied, for example, whenever the PCI count changes.

In some implementations, for example, in response to determining that the reporting is triggered, at 340, the UE may perform the reporting to the gNB via a measurement report. In an example implementation, the UE may report that 5 PCIs were detected within the power window during the PCI scanning operation. The PCI count may be used by the gNB to determine the noise and/or interference characteristics at the UE and/or SINR distributions (e.g., SINR standard deviations). Upon reporting of the PCIs found to the gNB or when the reporting is not triggered, the UE may return to performing scanning operations as the scanning may be a continuous operation).

In addition, in some implementations, for example, in response to the gNB configuring a plurality of power windows as described above, the UE may report PCI counts for both the power windows which may be related to the strength of dominant interferer vs other interferers. For instance, in an example implementation, the UE may report a PCI count of 2 for a 6 dB power window and a PCI count of 5 for a 10 dB window which may be used by the gNB to further assist with SINR distribution.

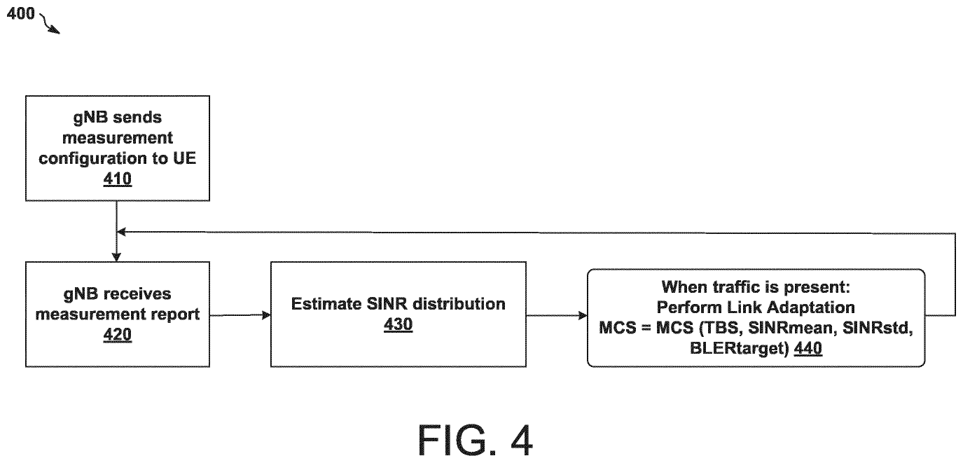

FIG. 4 illustrates a link adaptation mechanism 400, according to another additional example implementation.

At 410, a gNB, e.g., gNB 204 may send measurement configuration to a UE, e.g., UE 202. In some implementations, for example, the gNB may send the measurement configuration via, e.g., RRC/SRB, as described above.

At 420, gNB 204 may receive a measurement report from UE 202. In some implementations, for example, the gNB may receive a measurement report which may have been generated at the UE based at least on the measurement configuration transmitted by the gNB. In an example implementation, the measurement report may include mean signal values (Smean) and/or mean interference values (Imean). In another example implementation, the measurement report may include mean SINR values (SINRmean). In addition, the gNB may receive the number of PCIs (e.g., PCI count) detected by the UE within the power window.

At 430, gNB 204 may estimate SINR distribution characteristics. In some implementations, for example, the SINR distribution characteristics (e.g., SINR mean and standard deviation values) may be estimated based on information received at 420 where SINRmean may be provided directly by the UE or determined by the gNB based on information (e.g., Smean and Imean values) received from the UE.

At 440, when traffic is present (e.g., packets for transmission from the gNB to the UE), gNB 204 may perform link adaptation which may be based on the information determined (or available), for example, at 430. In some implementations, for example, the UE may determine an MCS for the next transmission (e.g., next packet) based at least on a combination of transport block size (TBS), SINR mean, SINR standard deviation, and/or block error ratio target (BLER target). A BLER may be generally defined as a ratio of number of erroneous blocks received to a total number of blocks sent and an erroneous block may be defined as a transport block for which the cyclic redundancy check (CRC) failed. In some implementations, for example, the BLER target may be set for a specific application or application types (e.g., URLLC) or for a quality of service (QoS) level. In some implementations, for example, a code block size (CBS) may be used instead of the TBS.

Once the gNB determines the MCS for the transmission, the gNB uses the determined MCS for transmitting the next transmission (e.g., next packet) to the UE using the determined (new) MCS. The selection of MCS based at least on the information received from the UE provides the mechanism for the gNB to efficiently/optimally select the MCS while satisfying the BLER target (or desired QoS level). Without this feedback mechanism, the MCS may be too high or too low, and the UE may fail to satisfy the BLER target or waste resources while satisfying the BLER target.

Thus, link adaptation mechanisms to support, for example, URLLC, as described above in reference to FIG. 2-4 may be performed by selecting the optimal MCS for transmissions from a gNB to a UE.

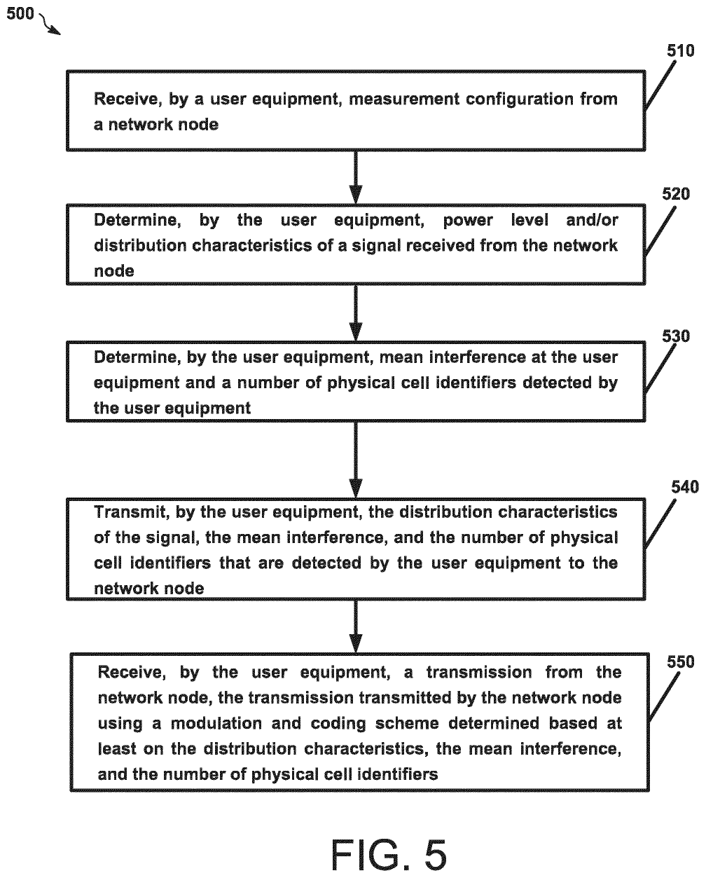

FIG. 5 is a flow chart 500 illustrating link adaptation mechanism, according to an example implementation.

In an example implementation, at block 510, a UE, e.g., UE 202, may receive measurement configuration from a network node. In some implementations, for example, as described above in reference to FIG. 2, the UE may receive measurement configuration via an SRB. In an example implementation, the measurement configuration may include measurement objects for measuring at the UE.

At block 520, the UE may determine power level and/or distribution characteristics of a signal received from the network node. In some implementations, for example, the UE may determine power level of a signal received from a serving cell (e.g., gNB 204), average power level (e.g., mean power over a given period), and/or standard distribution of the power level.

At block 530, the UE may determine mean interference at the UE and a number of physical cell identifiers detected by the user equipment. In some implementations, for example, the UE may determine the number of PCIs within a power window.

At block 540, the UE may transmit the distribution characteristics of the signal, the mean interference, and the number of physical cell identifiers that are detected by the user equipment to the network node. In some implementations, for example, the UE may transmit the distribution characteristics (e.g., determined at 520) and the PCI count (e.g., determined at 530) to the gNB.

At block 550, the UE may receive a transmission from the network node, the transmission transmitted by the network node using a modulation and coding scheme determined based at least on the distribution characteristics, the mean interference, and the number of physical cell identifiers. In some implementations, for example, the gNB may determine an MCS for a transmission based at least on SNIR distribution determined by the gNB. In some implementations, for example, the SNIR distribution may be determined based at least on the information transmitted to the gNB as described earlier in reference to 540.

Thus, the link adaptation may be performed for efficient communications by selecting an optimal MCS for a transmission to the UE based at least on the information received from the UE.

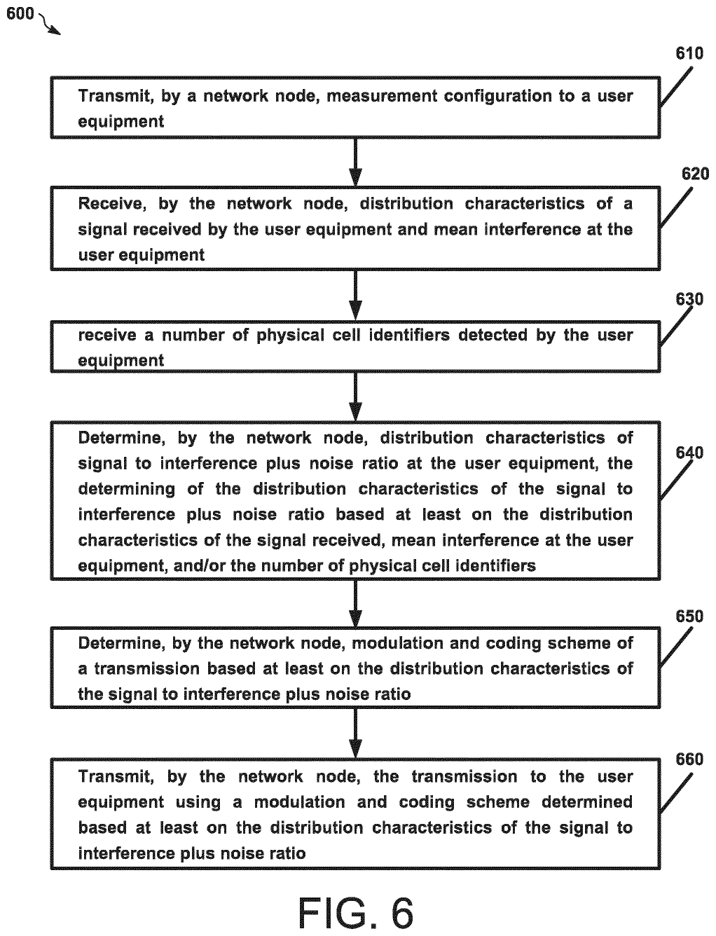

FIG. 6 is a flow chart 600 illustrating link adaptation mechanism, according to an additional example implementation.

In an example implementation, at block 610, a gNB, e.g., gNB 204 may transmit measurement configuration to a user equipment. In some implementations, for example, the gNB may transmit the measurement configuration via RRC/SRB.

At block 620, the gNB may receive distribution characteristics of a signal received by the user equipment and mean interference at the user equipment. In some implementations, for example, the distribution characteristics may include a mean power value and/or standard deviation power value of a signal transmitted from the gNB and/or the mean interference at the user equipment may include mean I or mean SINR.

At block 630, the gNB may receive a number of physical cell identifiers detected by the user equipment. In some implementations, for example, the gNB may receive a PCI count detected by the UE. In an example implementation, the PCI count may be based on a power window.

At block 640, the gNB may determine distribution characteristics of signal to interference plus noise ratio at the user equipment. In some implementations, the gNB may determine the SINR distribution based at least on the distribution characteristics of the signal received from the UE, mean interference at the user equipment, and/or the PCI count.

At block 650, the gNB may determine modulation and coding scheme of a transmission based at least on the distribution characteristics of the signal to interference plus noise ratio. For example, in some implementations, the MCS may be 64QAM, etc.

At block 660, the gNB may transmit the transmission to the user equipment using a modulation and coding scheme determined based at least on the distribution characteristics of the signal to interference plus noise ratio. In some implementations, for example, the gNB may transmit a packet from the gNB using 64QAM.

Thus, the link adaptation may be performed for efficient communications by selecting an optimal MCS for a transmission to the UE based at least on the information received from the UE.

Additional example implementations are described herein.

Example 1. A method of communications, comprising: receiving, by a user equipment, measurement configuration from a network node; determining, by the user equipment, power level and/or distribution characteristics of a signal received from the network node; determining, by the user equipment, mean interference at the user equipment and a number of physical cell identifiers detected by the user equipment; transmitting, by the user equipment, the distribution characteristics of the signal, the mean interference, and the number of physical cell identifiers that are detected by the user equipment to the network node; and receiving, by the user equipment, a transmission from the network node, the transmission transmitted by the network node using a modulation and coding scheme determined based at least on the distribution characteristics, the mean interference, and the number of physical cell identifiers.

Example 2. The method of Example 1, wherein determining the distribution characteristics of the signal received from the network node comprises: determining a standard deviation and a mean of the received signal power.

Example 3. The method of any of Examples 1-2, wherein determining the distribution characteristics of the signal received from the network node is based on a sample per resource element or a sample per physical resource block.

Example 4. The method of any of claims 1-3, further comprising: transmitting a channel quality indicator to the network node, and the modulation and coding scheme determined further based on the channel quality indicator transmitted to the network node.

Example 5. The method of any of Examples 1-4, wherein the resources comprise a synchronization signal block or a channel state information reference signal.

Example 6. The method of any of Examples 1-5, wherein the signal is a user-plane signal.

Example 7. The method of any of Examples 1-6, wherein determining the number of physical cell identifiers detected by the user equipment comprises: determining the number of physical cell identifiers detected by the user equipment within a power window.

Example 8. The method of any of Examples 1-7, wherein the power window is relative to a signal level of a serving cell.

Example 9. The method of any of Examples 1-8, wherein the modulation and coding scheme is selected to satisfy a desired quality of service level for the user equipment.

Example 10. A method of communications, comprising: transmitting, by a network node, measurement configuration to a user equipment; receiving, by the network node, distribution characteristics of a signal received by the user equipment and mean interference at the user equipment; receiving by the network node a number of physical cell identifiers detected by the user equipment; determining, by the network node, distribution characteristics of signal to interference plus noise ratio at the user equipment, the determining of the distribution characteristics of the signal to interference plus noise ratio based at least on the distribution characteristics of the signal received, mean interference at the user equipment, and/or the number of physical cell identifiers; determining, by the network node, modulation and coding scheme of a transmission based at least on the distribution characteristics of the signal to interference plus noise ratio; and transmitting, by the network node, the transmission to the user equipment using a modulation and coding scheme determined based at least on the distribution characteristics of the signal to interference plus noise ratio.

Example 11. The method of Example 10, wherein the distribution characteristics of the signal received by the user equipment comprises: a standard deviation and a mean of the signal received by the user equipment.

Example 12. The method of any of Examples 10-11, wherein the number of physical cell identifiers detected by the user equipment are within a power window.

Example 13. The method of any of Examples 10-12, wherein the modulation and coding scheme is determined based at least on a combination of: a transport block size; a signal to interference plus noise ratio mean value; a signal to interference plus noise ratio standard deviation value; and a target block error ratio.

Example 14. The method of any of Examples 10-13, further receiving: receiving a channel quality indicator from the user equipment, and the modulation and coding scheme of the transmission determined further based on the channel quality indicator received from the user equipment.

Example 15. The method of any of Examples 1-14, wherein the network node is a serving cell or a gNB.

Example 16. An apparatus comprising means for performing the method of any of Examples 1-15.

Example 17. A non-transitory computer-readable storage medium comprising instructions stored thereon that, when executed by at least one processor, are configured to cause a computing system to perform the method of any of Examples 1-15.

Example 18. An apparatus comprising: at least one processor; and at least one memory including computer program code, the at least one memory and the computer program code configured to, with the at least one processor, cause the apparatus at least to perform the method of any of Examples 1-15.

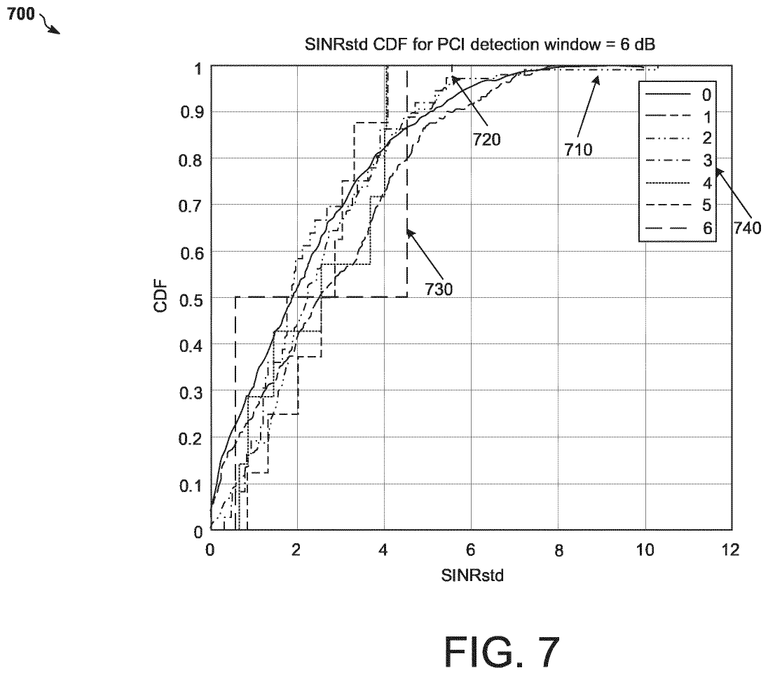

FIG. 7 is a chart illustrating CDFs of observed SINR standard deviation distributions, according to an example implementation. In some implementations, for example, the impact of detected PCI count to the interference (e.g., SINR) distribution may performed via simulation and results charted as shown in FIG. 7.

In FIG. 7, a range of SINRstd values may be observed for a power window (e.g., 6 dB) and different reported PCI counts (740). As shown in FIG. 7, the maximum value of an observed SINR distribution standard deviation becomes smaller as the number of detected PCIs increases. For example, when the detected PCI count is 0-2, the maximum SINRstd is ˜10 dB as shown at 710; when the detected PCI count is 3, the maximum SINRstd is ˜5.5 dB as shown at 720; and when the detected PCI count is >=4, the maximum SINRstd is about 4 dB as shown at 730. In addition, in some implementations, for example, the maximum values for SINRstd distributions may decrease with different power (detection) window sizes (e.g., higher maximum value for SINR std distributions for higher power window values).

The above described mechanisms provide for link adaptation to support communications, for example, URLLC, and may not be dependent on separate UE SINR distribution measurement/reporting procedures, but the UE may measure distribution characteristics of a signal from a serving cell, mean interference level at the UE, and detected PCIs in the vicinity of the UE within a power window. In some implementations, alternatively, the UE may report whether the threshold value is met (e.g., Yes/No), e.g., more than “Y” number of PCIs detected within a “X” dB power window.

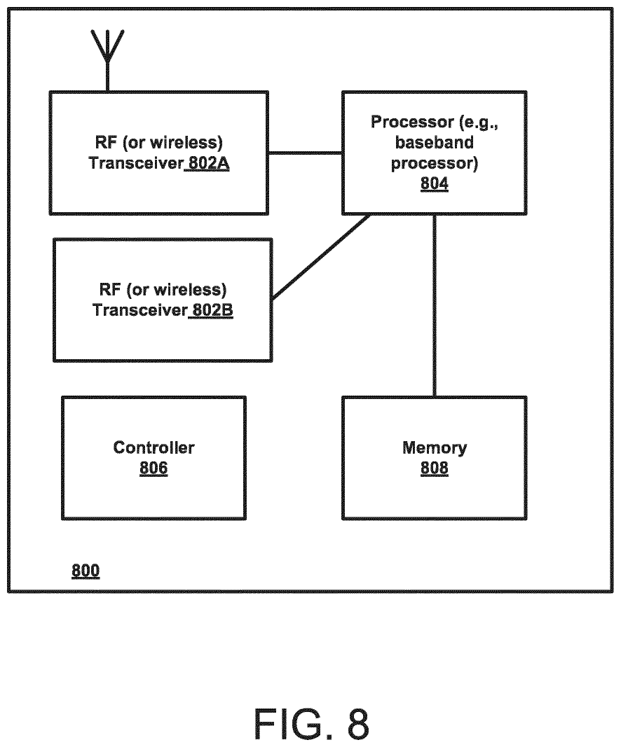

FIG. 8 is a block diagram of a wireless station (e.g., user equipment (UE)/user device or AP/gNB/MgNB/SgNB) 800 according to an example implementation. The wireless station 800 may include, for example, one or more RF (radio frequency) or wireless transceivers 802A, 802B, where each wireless transceiver includes a transmitter to transmit signals and a receiver to receive signals. The wireless station also includes a processor or control unit/entity (controller) 804/806 to execute instructions or software and control transmission and receptions of signals, and a memory 808 to store data and/or instructions.

Processor 804 may also make decisions or determinations, generate frames, packets or messages for transmission, decode received frames or messages for further processing, and other tasks or functions described herein. Processor 804, which may be a baseband processor, for example, may generate messages, packets, frames or other signals for transmission via wireless transceiver 802 (802A or 802B). Processor 804 may control transmission of signals or messages over a wireless network, and may control the reception of signals or messages, etc., via a wireless network (e.g., after being down-converted by wireless transceiver 802, for example). Processor 804 may be programmable and capable of executing software or other instructions stored in memory or on other computer media to perform the various tasks and functions described above, such as one or more of the tasks or methods described above. Processor 804 may be (or may include), for example, hardware, programmable logic, a programmable processor that executes software or firmware, and/or any combination of these. Using other terminology, processor 804 and transceiver 802 together may be considered as a wireless transmitter/receiver system, for example.

In addition, referring to FIG. 8, a controller 806 (or processor 804) may execute software and instructions, and may provide overall control for the station 800, and may provide control for other systems not shown in FIG. 8, such as controlling input/output devices (e.g., display, keypad), and/or may execute software for one or more applications that may be provided on wireless station 800, such as, for example, an email program, audio/video applications, a word processor, a Voice over IP application, or other application or software. Moreover, a storage medium may be provided that includes stored instructions, which when executed by a controller or processor may result in the processor 804, or other controller or processor, performing one or more of the functions or tasks described above.

According to another example implementation, RF or wireless transceiver(s) 802A/802B may receive signals or data and/or transmit or send signals or data. Processor 804 (and possibly transceivers 802A/802B) may control the RF or wireless transceiver 802A or 802B to receive, send, broadcast or transmit signals or data.

The aspects are not, however, restricted to the system that is given as an example, but a person skilled in the art may apply the solution to other communication systems. Another example of a suitable communications system is the 5G concept. It is assumed that network architecture in 5G will be quite similar to that of the LTE-advanced. 5G is likely to use multiple input—multiple output (MIMO) antennas, many more base stations or nodes than the LTE (a so-called small cell concept), including macro sites operating in co-operation with smaller stations and perhaps also employing a variety of radio technologies for better coverage and enhanced data rates.

It should be appreciated that future networks will most probably utilize network functions virtualization (NFV) which is a network architecture concept that proposes virtualizing network node functions into “building blocks” or entities that may be operationally connected or linked together to provide services. A virtualized network function (VNF) may comprise one or more virtual machines running computer program codes using standard or general type servers instead of customized hardware. Cloud computing or data storage may also be utilized. In radio communications this may mean node operations may be carried out, at least partly, in a server, host or node operationally coupled to a remote radio head. It is also possible that node operations will be distributed among a plurality of servers, nodes or hosts. It should also be understood that the distribution of labor between core network operations and base station operations may differ from that of the LTE or even be non-existent.

Implementations of the various techniques described herein may be implemented in digital electronic circuitry, or in computer hardware, firmware, software, or in combinations of them. Implementations may be implemented as a computer program product, i.e., a computer program tangibly embodied in an information carrier, e.g., in a machine-readable storage device or in a propagated signal, for execution by, or to control the operation of, a data processing apparatus, e.g., a programmable processor, a computer, or multiple computers. Implementations may also be provided on a computer readable medium or computer readable storage medium, which may be a non-transitory medium. Implementations of the various techniques may also include implementations provided via transitory signals or media, and/or programs and/or software implementations that are downloadable via the Internet or other network(s), either wired networks and/or wireless networks. In addition, implementations may be provided via machine type communications (MTC), and also via an Internet of Things (IOT).

The computer program may be in source code form, object code form, or in some intermediate form, and it may be stored in some sort of carrier, distribution medium, or computer readable medium, which may be any entity or device capable of carrying the program. Such carriers include a record medium, computer memory, read-only memory, photoelectrical and/or electrical carrier signal, telecommunications signal, and software distribution package, for example. Depending on the processing power needed, the computer program may be executed in a single electronic digital computer or it may be distributed amongst a number of computers.

Furthermore, implementations of the various techniques described herein may use a cyber-physical system (CPS) (a system of collaborating computational elements controlling physical entities). CPS may enable the implementation and exploitation of massive amounts of interconnected ICT devices (sensors, actuators, processors microcontrollers, . . . ) embedded in physical objects at different locations. Mobile cyber physical systems, in which the physical system in question has inherent mobility, are a subcategory of cyber-physical systems. Examples of mobile physical systems include mobile robotics and electronics transported by humans or animals. The rise in popularity of smartphones has increased interest in the area of mobile cyber-physical systems. Therefore, various implementations of techniques described herein may be provided via one or more of these technologies.

A computer program, such as the computer program(s) described above, can be written in any form of programming language, including compiled or interpreted languages, and can be deployed in any form, including as a stand-alone program or as a module, component, subroutine, or other unit or part of it suitable for use in a computing environment. A computer program can be deployed to be executed on one computer or on multiple computers at one site or distributed across multiple sites and interconnected by a communication network.

Method steps may be performed by one or more programmable processors executing a computer program or computer program portions to perform functions by operating on input data and generating output. Method steps also may be performed by, and an apparatus may be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer, chip or chipset. Generally, a processor will receive instructions and data from a read only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory may be supplemented by, or incorporated in, special purpose logic circuitry.

1. A method, comprising:
receiving, by a user equipment, measurement configuration from a network node;
determining, by the user equipment, power level and/or distribution characteristics of a signal received from the network node;
determining, by the user equipment, mean interference at the user equipment and a number of physical cell identifiers detected by the user equipment;
transmitting, by the user equipment, the distribution characteristics of the signal, the mean interference, and the number of physical cell identifiers that are detected by the user equipment to the network node; and
receiving, by the user equipment, a transmission from the network node, the transmission transmitted by the network node using a modulation and coding scheme determined based at least on the distribution characteristics, the mean interference, and the number of physical cell identifiers.

2. The method of claim 1, wherein determining the distribution characteristics of the signal received from the network node comprises:
determining a standard deviation and a mean of the received signal power.

3. The method of claim 1, wherein determining the distribution characteristics of the signal received from the network node is based on a sample per resource element or a sample per physical resource block.

4. The method of claim 1, further comprising:
transmitting a channel quality indicator to the network node, and
the modulation and coding scheme determined further based on the channel quality indicator transmitted to the network node.

5. The method of claim 1, wherein the resources comprise a synchronization signal block or a channel state information reference signal.

6. The method of claim 1, wherein the signal is a user-plane signal.

7. The method of claim 1, wherein determining the number of physical cell identifiers detected by the user equipment comprises:
determining the number of physical cell identifiers detected by the user equipment within a power window.

8. The method of claim 1, wherein the power window is relative to a signal level of a serving cell.

9. The method of claim 1, wherein the modulation and coding scheme is selected to satisfy a desired quality of service level for the user equipment.

10. A method, comprising:
transmitting, by a network node, measurement configuration to a user equipment;
receiving, by the network node, distribution characteristics of a signal received by the user equipment and mean interference at the user equipment;
receiving, by the network node, a number of physical cell identifiers detected by the user equipment;
determining, by the network node, distribution characteristics of signal to interference plus noise ratio at the user equipment, the determining of the distribution characteristics of the signal to interference plus noise ratio based at least on the distribution characteristics of the signal received, mean interference at the user equipment, and/or the number of physical cell identifiers;
determining, by the network node, modulation and coding scheme of a transmission based at least on the distribution characteristics of the signal to interference plus noise ratio; and
transmitting, by the network node, the transmission to the user equipment using a modulation and coding scheme determined based at least on the distribution characteristics of the signal to interference plus noise ratio.

11. The method of claim 10, wherein the distribution characteristics of the signal received by the user equipment comprises:
a standard deviation and a mean of the signal received by the user equipment.

12. The method of any of claim 10, wherein the number of physical cell identifiers detected by the user equipment are within a power window.

13. The method of claim 10, wherein the modulation and coding scheme is determined based at least on a combination of:
a transport block size;
a signal to interference plus noise ratio mean value;
a signal to interference plus noise ratio standard deviation value; and
a target block error ratio.

14. The method of claim 10, further receiving:
receiving a channel quality indicator from the user equipment, and
the modulation and coding scheme of the transmission determined further based on the channel quality indicator received from the user equipment.

15. The method of claim 1, wherein the network node is a serving cell or a gNB.

16. (canceled)

17. A non-transitory computer-readable storage medium comprising instructions stored thereon that, when executed by at least one processor, are configured to cause a computing system to perform the method of claim 1.

18. An apparatus comprising:
at least one processor; and
at least one memory including computer program code,
the at least one memory and the computer program code configured to, with the at least one processor, cause the apparatus at least to perform the method of claim 1.

19. An apparatus comprising:
at least one processor; and
at least one memory including computer program code,
the at least one memory and the computer program code configured to, with the at least one processor, cause the apparatus at least to perform the method of claim 10.

20. A non-transitory computer-readable storage medium comprising instructions stored thereon that, when executed by at least one processor, are configured to cause a computing system to perform the method of claim 10.
